(19) United States
(12) Patent Application Publication
(10) Pub. No.: US 2012/0079374 A1
(43) Pub. Date: Mar. 29, 2012

(54) RENDERING WEB PAGE TEXT IN A NON-NATIVE FONT

(75) Inventor: Matthew W. Gaddis, San Francisco, CA (US)

(73) Assignee: APPLE INC., Cupertino, CA (US)

(21) Appl. No.: 12/893,358

(22) Filed: Sep. 29, 2010

(51) Int. Cl. G06F 3/14

(52) U.S. Cl. 715/269

(57) ABSTRACT

Techniques are described herein for causing a browser to render text of a web page in a non-native font that do not require the browser to obtain font rendering information for characters defined in the non-native font that are not rendered on the web page in the non-native font. According to one embodiment, for example, a subset of the characters defined in a non-native font that are to be rendered on a web page in the non-native font is determined. Font rendering information is obtained from a remote resource for just the subset of characters and not for characters defined in the non-native font that are not in the subset. The font rendering information obtained for the subset is used to render each character in the subset on the web page in the non-native font.

### FIELD OF THE INVENTION

The present invention relates to rendering text in a web page and, in particular, to rendering text in a web page in a non-native font.

### BACKGROUND

Text in web pages is typically rendered by a browser in a particular font. The information needed to render web page text in a particular font is typically either locally available to the browser or must be obtained by the browser from a remote resource. For example, the operating system on which the browser executes typically includes information for rendering commonly used fonts. Thus, if web page text is to be rendered in one of these commonly used fonts, the browser can obtain font rendering information from the local operating system without having to communicate over a network with a remote resource to obtain the font rendering information. Such fonts for which font rendering information is locally available to the browser may be referred to as “native” fonts.

Often, however, text in a web page is to be rendered in an unusual, uncommon, or custom font for which rendering information is not locally available to the browser. To render web page text in one of these “non-native” fonts, the browser must obtain rendering information before the text can be rendered.

One approach for obtaining font rendering information for a non-native font is to include instructions in the web page for the browser to obtain, from a remote resource, a font-resource file containing font rendering information for the non-native font. For example, the instructions may include a Uniform Resource Locator (URL) at which the browser can download the font-resource file. A font-resource file can be many megabytes in size but typically ranges between 50 KB and 1 MB in size. Typically, a font-resource file contains font rendering information for rendering all characters in a character set in a particular font regardless of which characters included in the web page are actually rendered in the particular font. In other words, a font resource file for a particular font typically defines all characters in a character set in the particular font. Obtaining a font-resource file is wasteful of network and data storage resources if only a few characters of a character set are actually rendered in the web page in the non-native font.

Another approach for presenting text in a web page in a non-native font is to embed a digital image of the text in the non-native font in the web page. However, this approach is cumbersome for web page authors as a digital image must be created for each piece of text to be presented in the web page in the non-native font.

Based on the foregoing, it is clearly desirable to provide a mechanism for rendering text in a web page in a non-native font that does not require the browser to obtain font rendering information for characters defined in the non-native font that are not rendered in the web page in the non-native font.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a block diagram of a system for rendering text of a web page in a non-native font;

FIG. 2 is a block diagram of a computing device upon which embodiments may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### GLOSSARY

The following definitions are offered as an aide to the reader in understanding the following description and are not offered for purposes of limitation and should not be constructed as such.

Browser—Generally, a browser is a computer application that retrieves and renders Web content including text, graphics, sound, images, video, and other content types.

CSS—Cascading Style Sheets (CSS) is a style sheet language for authoring a presentation style (e.g., font, colors, and layout) to attach to structured documents (e.g., HTML documents). For further description of CSS, see e.g., “Cascading Style Sheets (CSS) Level 1 Specification”, a current World Wide Web Consortium (W3C) recommendation dated Dec. 17, 1996 and revised Apr. 11, 2008, the disclosure of which is hereby incorporated by reference as if fully set forth herein. A copy of this specification is available via the Internet (e.g., currently at /TR/2008/REC-CSS1-20080411 in the w3.org domain).

DOM—DOM is short for Document Object Model, a platform- and language-neutral interface that allows programs and scripts (e.g., Javascript) to dynamically access and update the content structure and style of documents (e.g., HTML documents). For further information on DOM, see e.g., “Document Object Model (DOM) Level 3 Core Specification, Version 1.0,” a current W3C recommendation dated Apr. 7, 2004, the disclosure of which is hereby incorporated by reference as if fully set forth herein. A copy of this specification is available on the Internet (e.g., currently at /TR/2004/REC-DOM-Level-3-Core-20040407 in the w3.org domain).

Font—A font represents an organized collection of glyphs that share a common “look and feel” such that, when a string of characters is rendered together the result conveys a particular artistic style and provides consistent inter-character alignment and spacing.

Glyph—A glyph is a unit of rendered content in a font. Typically, but not always, there is a one-to-one correspondence between a characters to be rendered and corresponding glyphs. Typically, a glyph is defined by one or more shapes such as a path representing the geometry of the outline of a two-dimensional object.

HTML—HyperText Markup Language (HTML) is the core markup language for authoring web pages on the World Wide Web. HTML describes the structure and layout of a web page using a standardized collection of tags and attributes. For further description of HTML, see e.g., “HTML5”, a current W3C working draft dated Jun. 24, 2010, the disclosure of which is hereby incorporated by reference as if fully set forth herein. A copy of this specification is available via the Internet (e.g., currently at /2010/WD-htm15-20100624 in the w3.org domain).

Javascript—Javascript is a small, lightweight object oriented scripting language designed to be embedded in other applications, such as Web browsers. Javascript code can be added to standard HTML web pages to create dynamic web pages. Most modern Web browsers include support for Javascript. For additional information on Javascript, see e.g., “Javascript Guide”, from Mozilla, the disclosure of which is hereby incorporated by reference as if fully set forth herein. A copy of this documentation is available via the Internet (e.g., currently at /en/JavaScript/Guide in the developer.mozilla.org domain).

SVG—Scalable Vector Graphics (SVG) is an XML-based language for describing two-dimensional vector graphics such as paths consisting of lines and arcs. For further description of SVG, see e.g., “Scalable Vector Graphics (SVG) 1.1 Specification”, a current W3C recommendation dated Jan. 14, 2003 and edited-in-place Apr. 30, 2009, the disclosure of which is hereby incorporated by reference as if fully set forth herein. A copy of this specification is available via the Internet (e.g., currently at /TR/2003/REC-SVG-20030114 in the w3.org domain).

URL—URL is an abbreviation for Uniform Resource Locator. A URL identifies a resource (e.g., a web page), where the resource is located on a network (e.g., the Internet), and the mechanism for retrieving the resource (e.g., a network protocol).

XML—XML stands for Extensible Markup Language, a specification developed by the W3C. XML is a set up markup rules for encoding documents in both a human-readable and computer-readable form. For further description of XML, see e.g., “Extensible markup Language (XML) 1.1 (Second Edition)”, a current W3C recommendation dated Aug. 16, 2009 and edited-in-place Sep. 29, 2006, the disclosure of which is hereby incorporated by reference as if fully set forth herein. A copy of this specification is available via the Internet (e.g., currently at /TR/2006/REC-xml11-20060816 in the w3.org domain).

### GENERAL OVERVIEW

Techniques are described herein for causing a browser to render text of a web page in a non-native font that do not require the browser to obtain font rendering information for characters defined in the non-native font that are not rendered on the web page in the non-native font. According to one embodiment, for example, a subset of the characters defined in a non-native font that are to be rendered on a web page in the non-native font is determined. Font rendering information is obtained from a remote resource for just the subset of characters and not for characters defined in the non-native font that are not in the subset. The font rendering information obtained for the subset is used to render each character in the subset on the web page in the non-native font.

For example, in one embodiment, the font rendering information is per-character font drawing information that can be used to cause the browser to render the subset of the characters in the non-native font. In such an embodiment, after the subset of characters to be rendered in the non-native font is identified, font drawing information is obtained for each distinct character in the subset. Prior to or during rendering of the web page by the browser and based on the obtained font drawing information, the text in the web page to be rendered in the non-native font is replaced with browser-executable font drawing instructions for rendering the text in the non-native font. When the web page is rendered by the browser, the browser executes the font drawing instructions included in the web page causing the text to be presented in the non-native font.

According to one embodiment, the font drawing information for a character is based on a vector graphics language description of one or more glyphs representing the character and the browser-executable font drawing instructions for the character are for rendering the one or more glyphs on a browser-supported vector graphics drawing surface. SVG is one example of a vector graphics language upon which per-character font drawing information may be based. Instead of or in addition to SVG, per-character font drawing information may be based other vector graphics languages such as, for example, the Vector Markup Language (VML). An HTML 5 Canvas element is one example of a browser-supported vector graphics drawing surface for rendering the one or more glyphs of a character in a particular font. However, other browser-supported vector graphics drawing surfaces may be used. For example, VML-based, a Java-based, a Flash/Flex-based, or a SVG-based drawing surface may be used.

### Per-Character Font Drawing Information

As mentioned, in one embodiment, after the subset of the characters defined in the in the non-native font is identified, font drawing information is obtained from a remote resource for each distinct character in the subset. In one embodiment, font drawing information obtained for a character comprises (a) an identifier of the character according to a character set (e.g., ASCII, ISO 8859-1, Unicode, etc.) and (b) a sequence of vector graphics drawing commands for drawing one or more glyphs that represent the character in the non-native font on a browser-supported vector graphics drawing surface (e.g., an HTML 5 Canvas). Font drawing information obtained for a character is font dependent. That is, the sequence of vector graphics drawing commands will vary depending on the font the character is to be rendered in. Thus, unless otherwise apparent from context, references in this description to “font drawing information” or “per-character font drawing information” are in the context of a particular font.

According to one embodiment, font drawing information for a character is derived from a vector graphics language definition of one or more glyphs representing the character according to a particular font. A vector graphics language definition for a character may be conceptually compared to a writing pen which is moved to a starting position in a two-dimensional plane and then draws a line or curve to the next reference point and so on until the complete contour of the one or more glyphs representing the character according to the particular font is drawn. The vector graphics language definition may include other commands for coloring or shading glyphs. For example, the following example XML includes a vector graphics language definition in SVG format for the uppercase “A” character in a particular font named “sf0”:

<font horiz-adv-x=“1000”>

<font-face font-family=“sf0” units-per-em=“1000”
underline-position=“−100” underline- thickness=“50”/>

<missing-glyph horiz-adv-x=“500” d=“M63,0 10,750 1375,0
10,−750 M125,63 1250,0 10,625 1-250,0 z”/>

<glyph unicode=“A” horiz-adv-x=“615” d=“M591,0
1-115,0 1-63,198 1-219,0 1-60,−198 1-112,0 1217,674
1134,0 M394,281 1-57,176 C331,475 320,517 303,584
1-2,0 C294,555 284,513 269,457 1-56, 176 z”/>

</font>

In the above example, the “d” attribute of the <glyph> element comprises vector graphics path data (e.g., drawing commands and coordinates) defining the contour of a glyph. In SVG, the coordinates are expressed in units that are relative to an abstract square known as the “em square”. The em square is the design grid on which glyph contours of a font are defined. The value of the “units-per-em” attribute of the <font-face> element specifies how may units the em square is divided into for the font.

Given a vector graphics language description of a character in a font, font drawing information for the character is derived from the vector graphics language description of the character. In one embodiment, the font drawing information for a character comprises essentially the vector graphics path data used in the vector graphics language description of the character. For example, in an embodiment in which the vector graphics language description for a character is based on SVG, font drawing information may comprise essentially the path data of the “d” attribute of an <glyph> element. When deriving font drawing information for a character, the path data (e.g., vector graphics commands and coordinates) used in the vector graphics language may be normalized or otherwise transformed into a format more suitable for drawing the glyph on a particular browser-supported vector graphics drawing surface. For example, coordinates of the path data may be multiplied by a constant value or undergo other mathematical normalizations or transformations.

As an illustrative example, the following is a text representation of a two-level associative array data structure comprising normalized font drawing information for the uppercase “A” character in a font named “sf0” according to an embodiment of the invention. In particular, in this example, the normalized font drawing information was derived from the above example SVG vector graphics language description of the uppercase “A” character for the “sf0” font.

The text representation of a two-level associative array data structure comprising exemplary normalized font drawing information follows:

[‘sf0’] [‘\\u0041’] = [

[“M”, 0.591, 0.0],
[“l”, −0.115, 0.0],
[“l”, −0.063, 0.198],
[“l”, −0.219, 0.0],
[“l”, −0.06, −0.198],
[“l”, −0.112, 0.0],
[“l”, 0.217, 0.674],
[“l”, 0.134, 0.0],
[“M”, 0.394, 0.281],
[“l”, −0.057, 0.176],
[“C”, 0.331, 0.475, 0.32, 0.517, 0.303, 0.584],
[“l”, −0.002, 0.0],
[“C”, 0.294, 0.555, 0.284, 0.513, 0.269, 0.457],
[“l”, −0.056, −0.176],
[“z”],
[“T”, 0.615, 0.0]

]

In the above example, normalized font drawing information, the first level of the associative array is keyed by the name of the font (e.g., “sf0”). The second level of the associative array is keyed by the Unicode value for a character (e.g., hexadecimal 41 is the Unicode value for uppercase “A”). Each element in the two-level associative array comprises a sequence of vector graphics drawing commands for rendering a particular Unicode character in a particular font on a browser-supported vector graphics drawing surface. For example, the element at [‘sf0’] [‘\\u0041’] in the associative array comprises a sequence of vector graphics drawing commands for rendering uppercase “A” in the “sf0” font. Each vector graphics drawing command in the sequence comprises a vector graphics command identifier (e.g., “M” for absolute moveto, “C” for absolute curveto, “1” for relative lineto, “z” for closepath, etc.) and command specific arguments. In one embodiment, the command specific arguments are derived and normalized by dividing the coordinates in the vector graphics language description of the character by the number of units per em square as specified in the vector graphics language description. For example, a normalized vector graphics drawing command of [‘M’, 0, −0.1] may be derived from an SVG description that includes the command “M0,−100” and that specifies units-per-em=“1000”.

In the above example, the last vector graphics drawing command [“T”, 0.615, 0.0] advances the vector graphics drawing surface on which the uppercase “A” character is rendered based on the SVG “horiz-adv-z” and “horiz-adv-y” values in preparation for drawing the next character or glyph. The horizontally oriented text advance values (e.g., the SVG “horiz-adv-z” and “horiz-adv-y” values) have been normalized in the last vector graphics drawing command by dividing the SVG “horiz-adv-z” and “horiz-adv-y” values by the number of “units-per-em”.

In one embodiment, vector graphics language descriptions of characters in a font are created and stored by a computer application for designing fonts and capable of exporting vector graphics language descriptions of a designed font in a particular data format (e.g., SVG). Adobe Illustrator® is an example of commercially available computer application for designing fonts that is capable of exporting an SVG description of a designed font. Other techniques, methods, and font designing applications may be used to obtain or create a vector graphics language description for a font and embodiments of the invention are not limited to any particular technique, method or application.

According to one embodiment, font drawing information is derived from vector graphics language descriptions for characters in a particular font and made available on a per-character basis. Making font drawing information available on a per-character basis involves constructing an index data structure in which font drawing information for a set of characters is stored and by which the font drawing information for a particular character in a particular font may be obtained. For example, the index data structure may be an two-level associative array in which the first level is keyed by the name the particular font and the second level is keyed by the character code of the particular character according to a particular character set (e.g., ASCII, ISO 8859-1, Unicode, etc.). If there is only one font for which per-character font drawing information is available, then the associative array may comprise only a single level. Data structures other than an associative array may be used to implement the index data structure and embodiments of the invention are not limited to any particular data structure. For example, per-character font drawing information may be stored in one or more relational database tables or other type of database where it is indexed by and accessible via a database management system.

According to one embodiment, font drawing information is made available for download from a remote server over a network on a per-character basis. The server may receive a request for font drawing information (e.g., a HTTP request). The request specifies a set of one or more fonts for which font drawing information is desired. The specification of a font in the request may be an identifier of the font such as a name of the font. For each of the one or more fonts, a set of one or more characters is also specified in the request. Each character may be specified in the request by a corresponding character code according to a particular character set (e.g., ASCII, ISO 8859-1, Unicode, etc.). Upon receiving the request, the server consults the index data structure to retrieve and return the requested font drawing information to the requestor. By making font drawing information available in this manner, a network requestor (e.g., a browser) can selectively obtain font rendering information for just one character or a few characters defined in a non-native font and need not obtain font rendering information for all characters defined in the non-native font when only one or a few characters are to be rendered in the non-native font.

### Example System for Rendering Web Page Text in a Non-Native Font

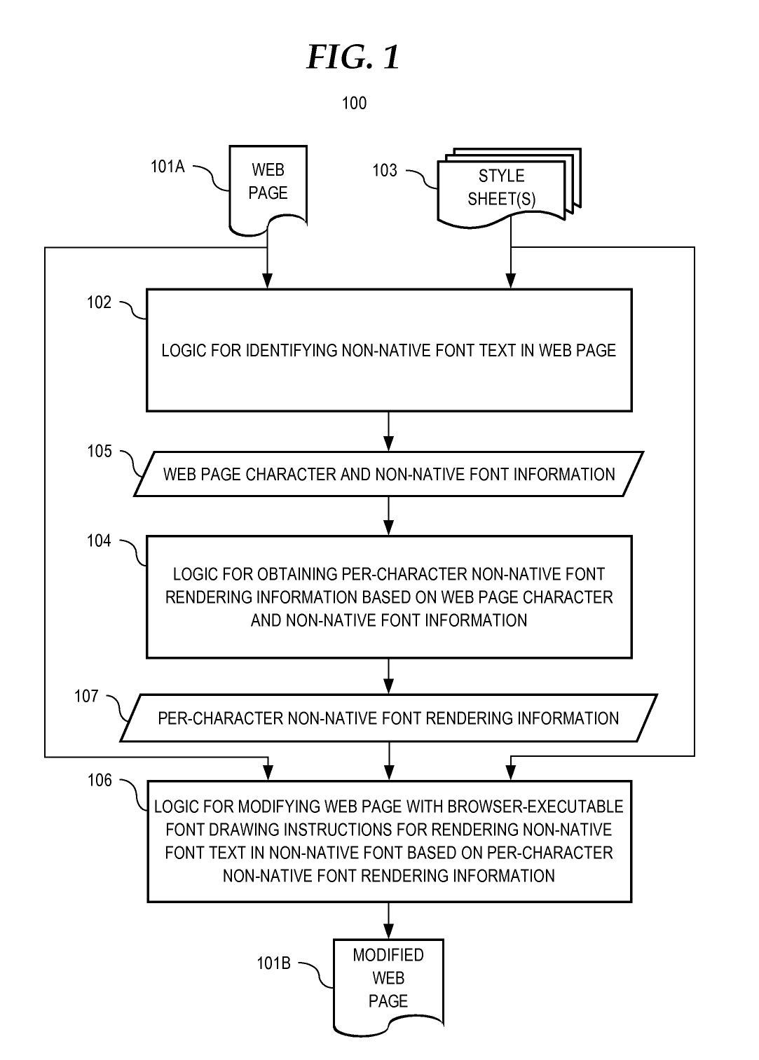

Referring to FIG. 1, it is a block diagram of a system for causing a browser to render web page text in a non-native font. In the example illustrated in FIG. 1, the system comprises logic 102 for identifying non-native font text in a web page 101A, logic 104 for obtaining per-character non-native font rendering information for only the distinct characters of the text identified by logic 102, and logic 106 for modifying web page 101A with browser-executable font drawing instructions to produce modified web page 101B based on the per-character non-native font rendering information obtained by logic 104. The modified web page 101B, when rendered by the browser, causes the non-native font text identified by logic 102 to be presented in the non-native font.

In one embodiment, system 100 is implemented by one or more Javascript programs that execute when web page 101A is loaded by a browser. For example, the Javascript program may be embedded in or linked by the web page 101A and execution of the one or more Javascript programs initiated in response to the occurrence of a Javascript “onload” event. In another embodiment, system 100 is implemented as one or more server side scripts or server-side computer programs that operate on a web page 101A to produce a modified web page 101B before the modified web page 101B is served by the server to a browser for rendering.

The browser may be virtually any standard web browser that provides support for a vector graphics drawing surface that may be commanded to draw vector graphics according to a specified set of drawing instructions. The HTML 5 <canvas> is one example of such a vector graphics drawing surface and is supported by the current latest version of popular browsers (e.g., Mozilla Firefox, Google Chrome, Internet Explorer 9, Safari, and Opera). However, it should be understood that browsers that support other types of vector graphics drawing surfaces may be used and embodiments of the invention are not limited to only browsers that support the HTML 5 <canvas> or its successive implementations.

Logics 102, 104, and 106 may be implemented in software, hardware, or a combination thereof. Logics 102, 104, and 106 within system 100 can be communicatively coupled to one or more each other. Though logics 102, 104, and 106 are described as being separate or distinct, one or more of logics 102, 104, and 106 may be combined in a single logic, routine, or program. The functional description provided herein including separation of responsibility for distinct functions is merely by way of example. Other groupings or other divisions of functional responsibilities can be made as necessary or in accordance with design preferences.

Web page 101A is any HTML formatted web page containing text to be rendered in a non-native font. In terms of a DOM representation, the web page 101A may be viewed as a tree of nodes in which some of the nodes are text nodes corresponding to HTML elements comprising text to be rendered in a non-native font. One or more cascading style sheets 103 may optionally be embedded in or linked by web page 101A. The author of web page 101A may specify a non-native font for text of the web page 101A in the same manner that native fonts are specified for text of the web page 101A. For example, the author may use the HTML <font> element in the web page 101A or declare a font to be applied to the text in an associated style sheet 103. System 100 identifies the text of the web page 101A that needs to be rendered in a non-native font by analyzing the HTML of the web page 101A and any associated style sheets 103 and modifies the web page 101A as necessary to cause the text to be displayed in the non-native font when the web page 101A is rendered in a browser. Thus, the techniques described herein do not require web page authors to specify non-native fonts for text any differently from how native fonts for text are specified.

### Identifying Non-Native Font Text

In operation, identification logic 102 accepts as input the web page 101A and any associated style sheets 103 that are embedded in or linked to the web page 101A. The output of logic 102 comprises web page character and non-native font information 105. Web page character and non-native font information 105 comprises, for each non-native font to be applied to text of the web page 101A, an identifier of the non-native font and identifiers of the set of characters of web page 101A that are to be rendered in the non-native font. For example, the non-native font identifier may be a text string specifying the name of the non-native font family and the identifiers of the non-native font characters may be a sequence, array, or list of character codes according to a particular character set (e.g., the ASCII, ISO 8859-1, or Unicode character sets).

Identifying text of the web page 101A to be rendered in a non-native font includes parsing or analyzing the HTML formatted source code of the web page 101A to identify any text that the web page author specified is to be rendered in a non-native font. Such identification can be accomplished through a variety of techniques and embodiments of the invention are not limited to any particular technique. In one embodiment, identifying such text includes enumerating HTML elements of the web page 101A to identify which of the HTML elements apply a non-native font to any text that might be contained within the HTML elements. Such enumeration may be accomplished, for example, using a suitable DOM API such as, for example, Javascript. However, other DOM APIs may be used.

In one embodiment, identifying an HTML element that applies a non-native font includes checking for the existence of a “class” attribute of the HTML element and, if the HTML element specifies a “class” attribute, then checking the value of the “class” attribute to determine if the value matches any in a pre-defined set of class attribute values that correspond to style sheet classes known to apply a non-native font. For example, consider the following portion of HTML code that may be included in a web page such as web page 101A:

<h1 class “SF”>iPad</h1>

In the above example, if class “SF” is one of the values in the pre-defined set of class attribute values that correspond to style sheet class known to apply a non-native font, then, according to this embodiment, logic 102 would identify that <h1> HTML element as an element of the web page 101A that applies a non-native font to any text contained within the element (in this example the text “iPad”).

Other techniques may be employed to identify text of web page 101A to be rendered in a non-native font and embodiments are not limited to any particular techniques. For example, logic 102 may apply one or more regular expressions to the HTML formatted source of the web page 101A.

After identifying text of the web page 101A to be rendered in a non-native font, logic 102 identifies the particular non-native font the text is to be rendered in. Generally, identification of the particular non-native font is accomplished by analyzing any font-related HTML rules from the web page 101A and any font-related style sheet rules from any style sheets 103 that would be applied to the text when those rules are interpreted by a browser. For example, reconsider the example HTML code above involving the <h1> element in light of the following cascading style sheet font declaration for style class “SF”:

SF {

font-family: “MyCustomFont”, Arial, Helvetica, sans-serif
font-size: 13px
font-weight: normal

}

In this example, by virtue of the class=“SF” attribute/value of the <h1> element, a browser applies the above font declaration of the SF class definition to “iPad” within the <h1> HTML element. In an embodiment in which text to be rendered in a non-native font is identified by the class attribute of HTML elements, the non-native font is identified by determining the highest priority “font-family” declared in the corresponding style sheet class definition. Under the rules of CSS, a style sheet author can use the “font-family” property to list in preferential order font families to use when rendering text. In the above example and according to the current embodiment, logic 102 would identify “MyCustomFont” as the non-native font to be applied to the text within the <h1> HTML element.

Other techniques may be employed to identify a particular non-native font that text of web page 101A is to be rendered in and embodiments are not limited to any particular techniques.

As shown in FIG. 1, the output of logic 102 is web page character and non-native font information 105. Information 105 is used by logic 104 to obtain per-character non-native font rendering information 107 (e.g., from a remote server). In one embodiment, information 105 comprises, for each non-native font to be applied to text of web page 101A, an identifier of the non-native font (e.g., the font-family name) and an identifier of each distinct character in the web page 101A that is to be rendered in the non-native font. In another embodiment, information 105 comprises, for each distinct character in the web page 101A to be rendered in a non-native font, an identifier of the distinct character and an identifier of each non-native font the distinct character is to be rendered in. Characters may be identified by the numerical character code according to a standard character set (e.g., the ASCII, ISO 8859-1, or Unicode character sets).

### Obtaining Per-Character Non-Native Font Rendering Information

Instead of obtaining font rendering information for rendering all characters in a character set regardless of which characters included in the web page 101A are actually rendered in a non-native font, logic 104 uses information 105 to obtain per-character font rendering information for just the subset of the characters of the web page 101A that are to be rendered in a non-native font and not for characters of the web page 101A that are not to be rendered in a non-native font.

In one embodiment, obtaining per-character font rendering information includes the browser rendering the web page 101A sending a network request to a server for the per-character font rendering information (e.g., an Ajax, HTTP, or TCP/IP-based request). The request may include information 105 or portions or variants thereof. In response to the request, per-character non-native font rendering information 107 is received at the browser. In one embodiment, information 107 is received at the browser packaged as a JavaScriptObjectNotation (JSON) object or other suitable data format for packaging and exchanging information between a browser and a server.

In another embodiment, obtaining per-character font rendering information includes consulting or accessing an index data structure or other body of data to obtain the per-character font rendering information 107 using information 105 as a key or keys when consulting or accessing the index data structure or other body of data.

In one embodiment, information 107 comprises per-character font drawing information. In particular, for each non-native font to be applied to text of web page 101A, information 107 includes font drawing information for each distinct character in the web page 101A that is to be rendered in the non-native font. For example, returning to the “iPad” example above, information 107 may comprise font drawing information for rendering the character ‘i’ in the ‘MyCustomFont’ font, font drawing information for rendering the character ‘P’ in the ‘MyCustomFont’ font, font drawing information for rendering the character ‘a’ in the ‘MyCustomFont’ font, and font drawing information for rendering the character ‘d’ in the ‘MyCustomFont’ font.

### Modifying the Web Page with Browser-Executable Font Drawing Instructions

Logic 106 uses per-character non-native font rendering information 107 to modify web page 101A with browser-executable font drawing instructions for rending the non-native font text identified by logic 102, and for which the per-character font rendering information 107 was obtained by logic 104, to produce modified web page 101B. Modified web page 101B, when rendering by a browser, causes each identified piece of non-native font text in web page 101A to be presented in the browser in its corresponding non-native font.

According to one embodiment, modifying web page 101A with browser-executable font drawing instructions includes replacing each contiguous piece of text in web page 101A that is to be rendered in a non-native font, as identified by logic 102, with corresponding browser-executable font drawing instructions. The corresponding browser-executable font drawing instructions, when executed or interpreted by a browser, cause each character of the contiguous piece of text to be drawn on a browser-supported vector graphics drawing surface.

In one embodiment, the corresponding browser-executable font drawing instructions include HTML code for rendering a browser-supported vector graphics drawing surface of a specified dimension at or near the location in web page 101A of the contiguous piece of text that is being replaced by the corresponding drawing instructions. The specified dimension may be based on the number of characters to be rendered on the drawing surface and/or properties of the non-native font that the contiguous piece of text is to be rendered in as specified in the web page 101A or a style sheet 103. For example, the specified dimension may be based on values of a font-size property or a line-height property specified in a style sheet declaration of the non-native font. In this way, the corresponding browser-supported vector graphics drawing surface can be configured to cover roughly the same graphical area of the web page as would be covered by the contiguous piece of text that is being replaced.

The corresponding browser-executable font drawing instructions also include drawing commands for drawing each character of the contiguous piece of text on the browser-supported vector graphics drawing surface. The drawing commands are based on the per-character non-native rendering information 107 obtained by logic 104. In particular, for each character of the contiguous piece of text, information 107 is accessed to obtain the per-character font drawing information for the character. Generally, information 107 is accessed according to an identifier of the non-native font that the character is to be rendered in (e.g., a name of the font) and an identifier of the character (e.g., a character code for the character according to a particular character set). The obtained font drawing information for the character may be modified or otherwise transformed or translated by logic 106 to produce a corresponding set of one or more drawing commands for drawing the character on a particular browser-supported vector graphics drawing surface. For example, in one embodiment, font drawing information for a character is translated into a set of one or more Javascript instructions for drawing the character on an HTML 5 <canvas>. Thus, logic 104 may obtain the same font drawing information for a character to be used with multiple types of browser-supported vector graphics drawing surfaces regardless of the particular type of drawing surface the character is actually drawn on.

In one embodiment, since font drawing information for a character is based on a scalable vector graphics description of the character, the obtained font drawing information for a character may be mathematically modified or otherwise mathematically transformed or mathematically translated by logic 106 to accommodate a font-size property associated with the non-native font the character is to be rendered in. For example, in one embodiment, logic 106 multiples the coordinates in font drawing information obtained for a character by the value of the font-size property and the modified coordinates are used by logic 106 to produce a set of one or more drawing commands for drawing the character on a browser-supported vector graphics drawing surface. Thus, logic 104 may obtain the same font drawing information for a character to be used with multiple font sizes regardless of the actual font size the character is rendered in.

In one embodiment, each contiguous piece of text replaced by browser-executable font drawing instructions is retained in the modified web page 101B as textual metadata where it can be scanned and detected by screen readers or text-based search engines.

### Non-Native Font Family Variants

As mentioned, a non-native font may be identified by a name. This name may be used by logic 104 and logic 106 to obtain per-character non-native font rendering information 107 for the non-native font. In one embodiment, the name of the non-native font used by logics 104 and 106 is the font family name for the non-native font specified by the web page author as identified by logic 102 in the web page 101A or a style sheet 103 (e.g., the first font family specified in a “font-family” CSS property). In addition to a font family, the web page author may also specify in the web page 101A or a style sheet 103 a particular font style (e.g., normal, italic, oblique) within the font family that is to be applied to text rendered on the web page. For example, the web page author may use the “font-style” CSS property to apply a particular font style.

In one embodiment, logic 102 formulates a canonical name for a non-native font through a combination of the font family name and the font style specified for the non-native font by the web page author. This formulated name may be used by logics 104 and 106 to obtain per-character non-native font information. For example, assume logic 102 identifies in a style sheet 103 that the font family name for a non-native font is “CustomFont” and also identifies the font-style as “italic”. In this example, logic 102 may formulate the canonical name “CustomFont_italic” for logics 104 and 106 to use when obtaining per-character non-native font rendering information. By formulating a canonical name for a non-native font in this way, the web page author can declare properties of a non-native font in the web page 101A or a style sheet 103 in the same manner that a native font would be declared. Specifically, the web page author need not encode the font style into the font family name of the non-native font when declaring the non-native font in the web page 101A or a style sheet 103. A similar technique may be used to accommodate other types of variants within a font family such as, for example, language variants.

### Example Browser-Executable Font Drawing Instructions

The following are example browser-executable font drawing instructions for drawing the character “A” in a particular font on a browser supported drawing surface. In particular, the browser-executable font drawing instructions are Javascript instructions for drawing the character “A” in a particular font on a HTML 5 <canvas> element.

The example Javascript instructions follow:

canvas=document.createElement('CANVAS');
canvasContext=canvas.getContext(‘2d’);
canvasContext.setTransform(1, 0, 0, −1, 0, 12);
canvasContext.moveTo(7.092, 0);
canvasContext.lineTo(5.71, 0);
canvasContext.lineTo(4.954, 2.376);
canvasContext.lineTo(2.326, 2.376);
canvasContext.lineTo(1.606, 0);
canvasContext.lineTo(0.262, 0);
canvasContext.lineTo(2.866, 8.088);
canvasContext.lineTo(4.474, 8.088);
canvasContext.moveTo(4.728, 3.372);
canvasContext.lineTo(4.044, 5.484);
canvasContext.bezierCurveTo(3.972, 5.7, 3.84, 6.204, 3.636, 7.008);
canvasContext.lineTo(3.612, 7.008);
canvasContext.bezierCurveTo(3.528, 6.66, 3.408, 6.156, 3.228, 5.484);
canvasContext.lineTo(2.556, 3.372);
canvasContext.fill( );
canvasContext.translate(7.38, 0);
document.body.appendChild(canvas);

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

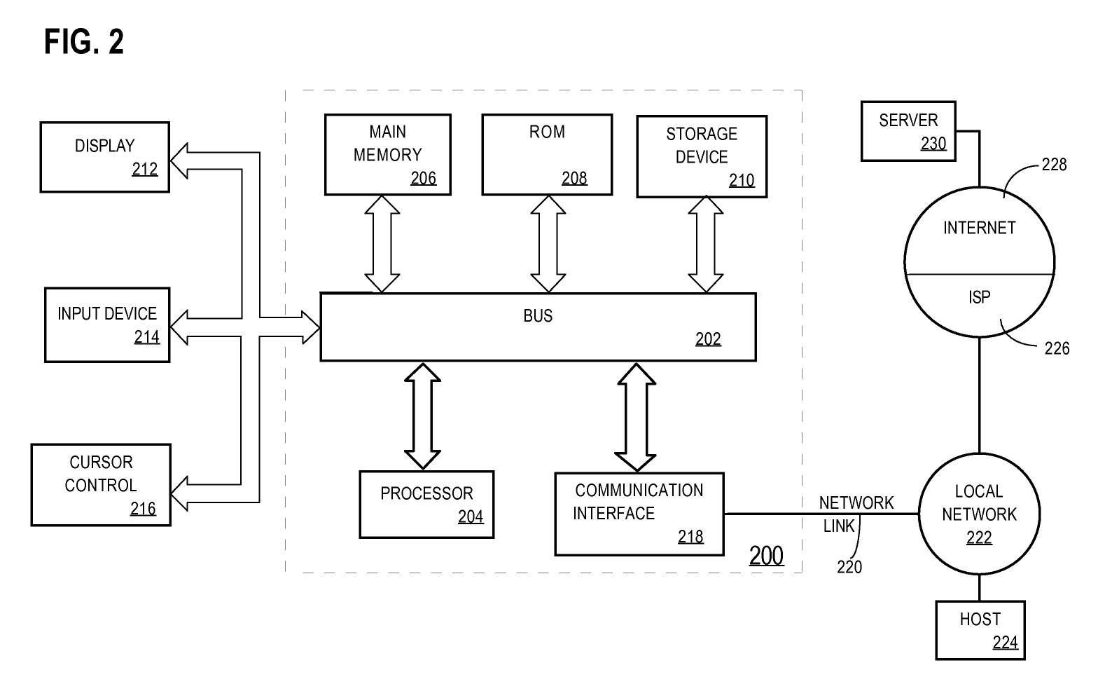

For example, FIG. 2 is a block diagram that illustrates a computer system 200 upon which an embodiment of the invention may be implemented. Computer system 200 includes a bus 202 or other communication mechanism for communicating information, and a hardware processor 204 coupled with bus 202 for processing information. Hardware processor 204 may be, for example, a general purpose microprocessor.

Computer system 200 also includes a main memory 206, such as a random access memory (RAM) or other dynamic storage device, coupled to bus 202 for storing information and instructions to be executed by processor 204. Main memory 206 also may be used for storing temporary variables or other intermediate information during execution of instructions to be executed by processor 204. Such instructions, when stored in storage media accessible to processor 204, render computer system 200 into a special-purpose machine that is customized to perform the operations specified in the instructions.

Computer system 200 further includes a read only memory (ROM) 208 or other static storage device coupled to bus 202 for storing static information and instructions for processor 204. A storage device 210, such as a magnetic disk or optical disk, is provided and coupled to bus 202 for storing information and instructions.

Computer system 200 may be coupled via bus 202 to a display 212, such as a cathode ray tube (CRT), for displaying information to a computer user. An input device 214, including alphanumeric and other keys, is coupled to bus 202 for communicating information and command selections to processor 204. Another type of user input device is cursor control 216, such as a mouse, a trackball, or cursor direction keys for communicating direction information and command selections to processor 204 and for controlling cursor movement on display 212. This input device typically has two degrees of freedom in two axes, a first axis (e.g., x) and a second axis (e.g., y), that allows the device to specify positions in a plane.

Computer system 200 may implement the techniques described herein using customized hard-wired logic, one or more ASICs or FPGAs, firmware and/or program logic which in combination with the computer system causes or programs computer system 200 to be a special-purpose machine. According to one embodiment, the techniques herein are performed by computer system 200 in response to processor 204 executing one or more sequences of one or more instructions contained in main memory 206. Such instructions may be read into main memory 206 from another storage medium, such as storage device 210. Execution of the sequences of instructions contained in main memory 206 causes processor 204 to perform the process steps described herein. In alternative embodiments, hard-wired circuitry may be used in place of or in combination with software instructions.

The term “storage media” as used herein refers to any media that store data and/or instructions that cause a machine to operation in a specific fashion. Such storage media may comprise non-volatile media and/or volatile media. Non-volatile media includes, for example, optical or magnetic disks, such as storage device 210. Volatile media includes dynamic memory, such as main memory 206. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 202. Transmission media can also take the form of acoustic or light waves, such as those generated during radio-wave and infra-red data communications.

Various forms of media may be involved in carrying one or more sequences of one or more instructions to processor 204 for execution. For example, the instructions may initially be carried on a magnetic disk or solid state drive of a remote computer. The remote computer can load the instructions into its dynamic memory and send the instructions over a telephone line using a modem. A modem local to computer system 200 can receive the data on the telephone line and use an infra-red transmitter to convert the data to an infra-red signal. An infra-red detector can receive the data carried in the infra-red signal and appropriate circuitry can place the data on bus 202. Bus 202 carries the data to main memory 206, from which processor 204 retrieves and executes the instructions. The instructions received by main memory 206 may optionally be stored on storage device 210 either before or after execution by processor 204.

Computer system 200 also includes a communication interface 218 coupled to bus 202. Communication interface 218 provides a two-way data communication coupling to a network link 220 that is connected to a local network 222. For example, communication interface 218 may be an integrated services digital network (ISDN) card, cable modem, satellite modem, or a modem to provide a data communication connection to a corresponding type of telephone line. As another example, communication interface 218 may be a local area network (LAN) card to provide a data communication connection to a compatible LAN. Wireless links may also be implemented. In any such implementation, communication interface 218 sends and receives electrical, electromagnetic or optical signals that carry digital data streams representing various types of information.

Network link 220 typically provides data communication through one or more networks to other data devices. For example, network link 220 may provide a connection through local network 222 to a host computer 224 or to data equipment operated by an Internet Service Provider (ISP) 226. ISP 226 in turn provides data communication services through the world wide packet data communication network now commonly referred to as the “Internet” 228. Local network 222 and Internet 228 both use electrical, electromagnetic or optical signals that carry digital data streams. The signals through the various networks and the signals on network link 220 and through communication interface 218, which carry the digital data to and from computer system 200, are example forms of transmission media.

Computer system 200 can send messages and receive data, including program code, through the network(s), network link 220 and communication interface 218. In the Internet example, a server 230 might transmit a requested code for an application program through Internet 228, ISP 226, local network 222 and communication interface 218.

The received code may be executed by processor 204 as it is received, and/or stored in storage device 210, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense.

What is claimed is:

1. A method comprising:
determining a subset of characters defined in a particular font that are to be rendered on a web page in the particular font;
obtaining, from a remote resource, font information for the particular font for just the subset of characters and not for characters defined in the particular font that are not in the subset; and
based on the obtained font information, causing each character in the subset to be rendered on the web page in the particular font;
wherein the method is performed by a computing device.

2. The method according to claim 1, wherein determining the subset of characters includes analyzing text of the web page to determine the subset of characters.

3. The method according to claim 1, wherein obtaining the font information for just the subset of characters includes obtaining the font information from a remote server.

4. The method according to claim 3, wherein obtaining the font information from a remote server includes sending a request to the remote server, the request comprising (a) an identifier of the particular font and (b), for each character in the subset, an identifier of the character.

5. The method according to claim 1, wherein the obtained font information comprises font drawing information for just the subset of characters and not for characters defined in the particular font that are not in the subset.

6. The method according to claim 5, wherein the font drawing information comprises, for each character in the subset, vector graphics drawing information for the character.

7. The method according to claim 6, wherein the vector graphics drawing information for a character is based on a vector graphics language description of the character.

8. The method according to claim 1, wherein causing each character in the subset to be rendered on the web page in the particular font includes replacing text of the web page with browser-executable font drawing instructions which, when executed or interpreted by a browser, cause the replaced text to be rendered on the web page in the particular font.

9. The method according to claim 8, wherein the browser-executable font drawing instructions comprise instructions for drawing the subset of characters on one or more browser-supported vector graphics drawing surfaces rendered on the web page.

10. The method according to claim 1, wherein the method is performed by one or more scripts executed by the computing device that are embedded in or linked by the web page.

11. A non-transitory computer-readable medium storing instructions which, when executed by one or more processors, cause the one or more processors to perform the method of claim 1.

12. A non-transitory computer-readable medium storing instructions which, when executed by one or more processors, cause the one or more processors to perform the method of claim 2.

13. A non-transitory computer-readable medium storing instructions which, when executed by one or more processors, cause the one or more processors to perform the method of claim 3.

14. A non-transitory computer-readable medium storing instructions which, when executed by one or more processors, cause the one or more processors to perform the method of claim 4.

15. A non-transitory computer-readable medium storing instructions which, when executed by one or more processors, cause the one or more processors to perform the method of claim 5.

16. A non-transitory computer-readable medium storing instructions which, when executed by one or more processors, cause the one or more processors to perform the method of claim 6.

17. A non-transitory computer-readable medium storing instructions which, when executed by one or more processors, cause the one or more processors to perform the method of claim 7.

18. A non-transitory computer-readable medium storing instructions which, when executed by one or more processors, cause the one or more processors to perform the method of claim 8.

19. A non-transitory computer-readable medium storing instructions which, when executed by one or more processors, cause the one or more processors to perform the method of claim 9.

20. A non-transitory computer-readable medium storing instructions which, when executed by one or more processors, cause the one or more processors to perform the method of claim 10.

21. A non-transitory computer-readable medium storing instructions which, when executed by one or more processors, cause the one or more processors to perform the method of claim 11.

22. A computing device comprising:
first logic for determining a subset of characters defined in a particular font that are to be rendered on a web page in the particular font;
second logic operatively coupled to the first logic for obtaining, from a remote resource, font information for the particular font for just the subset of characters and not for characters defined in the particular font that are not in the subset; and
third logic operatively coupled to the first and second logic for causing, based on the obtained font information, each character in the subset to be rendered on the web page in the particular font.

23. The computing device of claim 22, wherein the web page is stored in one or more non-transitory computer-readable media of the computing device; and wherein the first, second, and third logic are implemented by one or more scripts embedded in or linked by the stored web page.
